(19) United States
(12) Patent Application Publication
(10) Pub. No.: US 2014/0211382 A1
(43) Pub. Date: Jul. 31, 2014

(54) ELECTRONIC DEVICE WITH KEYBOARD

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW)

(73) Assignee: HON HAI PRECISION INDUSTRY CO., LTD., New Taipei (TW)

(21) Appl. No.: 14/155,521

(22) Filed: Jan. 15, 2014

(30) Foreign Application Priority Data
Jan. 25, 2013 (TW) 102102751

(51) Int. Cl. G06F 1/16

(52) U.S. Cl. CPC G06F 1/16
USPC 361/679.01

(57) ABSTRACT

An electronic device includes a base, a display pivotally mounted to the base, and a keyboard mounted on the base. The base includes a layer of conductive rubber. The layer of conductive rubber includes a plurality of contact switches. The keyboard includes a board body and a plurality of elastic tabs extending slanted from the board body. Each of the plurality of elastic tabs corresponds to each of plurality of contact switches. Each of the plurality of elastic tabs is pressed to move to contact the corresponding contact switch to input information. The display rotates towards the base to press the plurality of the elastic tab to move towards the plurality of contact switches to contact the board body.

### BACKGROUND

1. Technical Field

The present disclosure generally relates to an electronic device with a keyboard.

2. Description of Related Art

A traditional electronic device includes a base and a display pivotally mounted to the base. The base has a keyboard. The keyboard includes a board body and a plurality of keys mounted on the board body. The display cannot contact the board body because of the keys located between the board body and the display, which limits the thickness of the traditional electronic device. With the trend towards miniturization, there is room for improvement within the art.

### BRIEF DESCRIPTION OF THE DRAWINGS

Many aspects of the embodiments can be better understood with parameters to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of one embodiment of an electronic device, showing the electronic device in an open configuration.

FIG. 2 is an isometric view of a layer of conductive rubber of the electronic device of FIG. 1.

FIG. 3 is an isometric view of a keyboard of the electronic device of FIG. 1.

FIG. 4 is an across-sectional view of the keyboard of FIG. 3.

FIG. 5 is an isometric view of one embodiment of an electronic device, showing the electronic device in a closed configuration.

### DETAILED DESCRIPTION

The disclosure is illustrated by way of example and not by way of limitation in the figures of the accompanying drawings in which like parameters indicate similar elements. It should be noted that parameters to “an” or “one” embodiment in this disclosure are not necessarily to the same embodiment, and such parameters mean “at least one.”

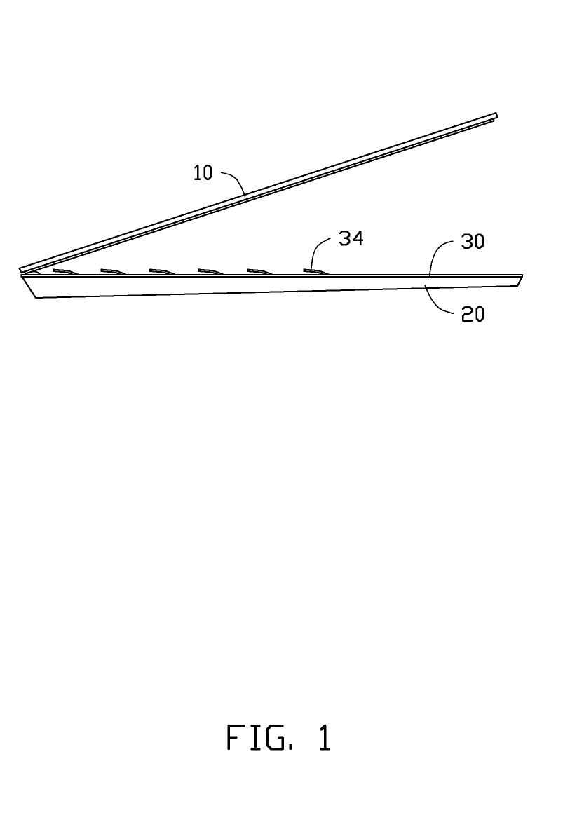

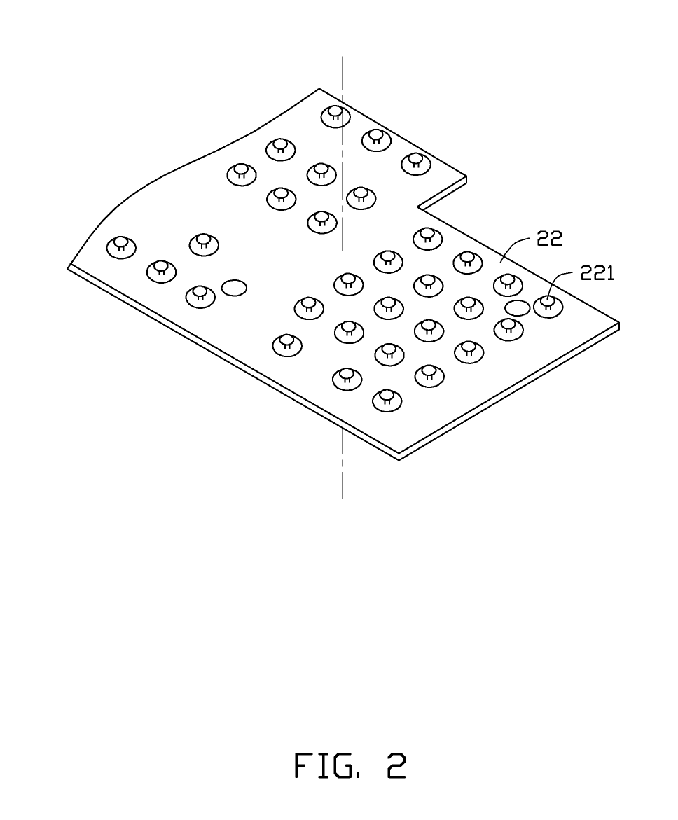

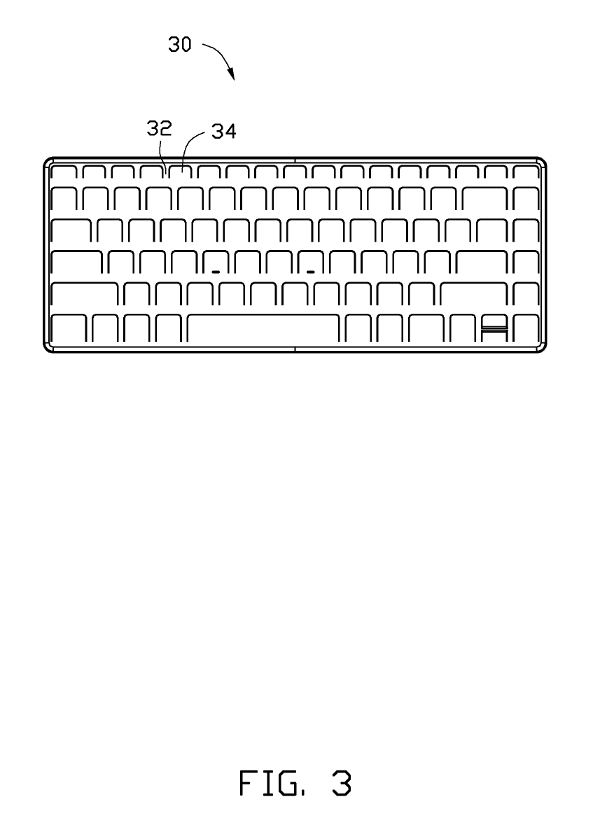

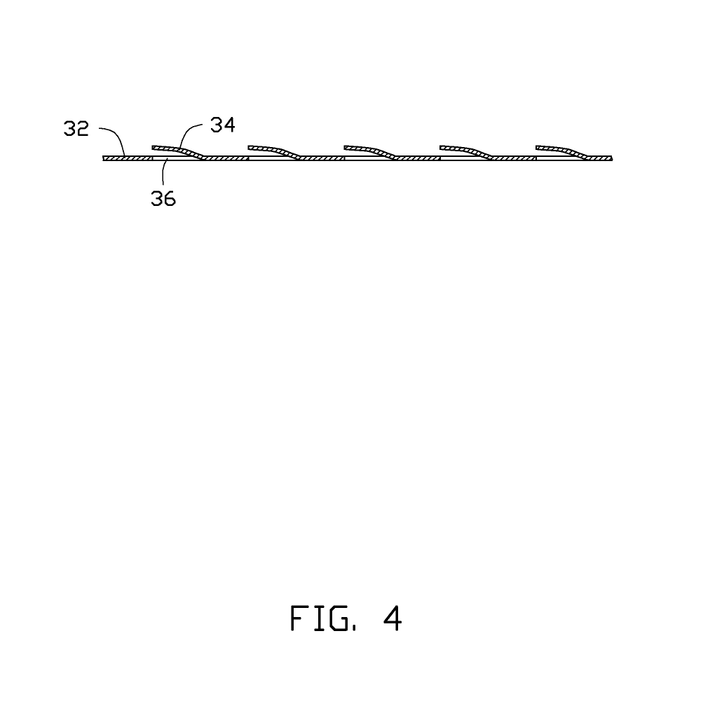

FIGS. 1 to 4 show an electronic device of one embodiment. The electronic device includes a display 10, a base 20 pivotally mounted to the display 10, and a keyboard 30 mounted on the base 20. In one embodiment, the electronic device is a notebook computer.

The base 20 includes a layer of conductive rubber 22. The layer of conductive rubber 22 defines a plurality of touch switches 221. Each touch switch 221 is used for inputting information, such as commands, characters, -letters, numbers, and so on, when each touch switch 221 is pressed.

The keyboard 30 includes a board body 32 and a plurality of keys mounted on the board body 32 corresponding to the touch switches 221. Each key includes an elastic tab 34 extending slantingly from the board body 32. The elastic tab 34 functions as a keycap. The elastic tab 34 is pressed to trigger the corresponding touch switch 221. The board body 32 and the elastic tab 34 can be made of metal. The board body 32 and the elastic tab 34 can be integrated. The elastic tabs 34 can be formed by punching. In one embodiment, the board body 32 defines a plurality of opening 36 created from punching the elastic tabs 34. The metal elastic tab 34 extends inward and slanted from an edge of the opening 36.

The cross section is substantially arc-shaped. The elastic tabs 35 can have different sizes. For example, the elastic tab 35 can functions as a “shift” key, an “Enter” key, or any key having a greater size than the other metal elastic tabs 35 that function as number keys or letter keys. The number keys and letter keys can have the same size.

The board body 32 is located on the layer of conductive rubber 22. The elastic tabs 34 are located on the corresponding touch switches 221. The elastic tab 34 is capable of passing through the corresponding opening 36 to contact the contact switch 221.

Each elastic tab 34 is in a free state when the display 10 is in an open status. The elastic tab 34 is elastically deformed by a user pressing the elastic tab 34 to trigger the corresponding touch switch 221. The elastic tab 34 returns to the free state after the external force is removed to the elastic tab 34.

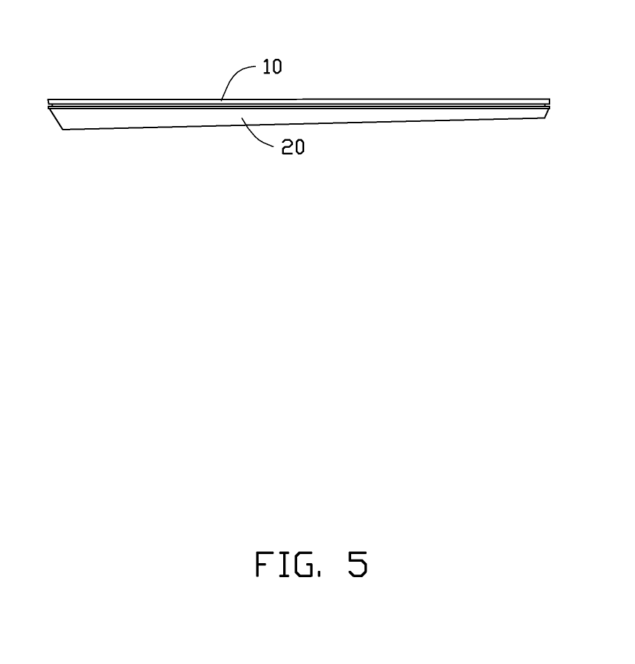

FIG. 5 shows that each elastic tab 34 is pressed by the display 10 into the corresponding opening 36 when the display 10 rotates toward the base 20 and contacts the board body 32, thereby decreasing the thickness of the electronic device.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base comprising a layer of conductive rubber, the layer of conductive rubber comprising a plurality of contact switches;
a display pivotally mounted to the base; and
a keyboard mounted on the base, wherein the keyboard comprises a board body and a plurality of elastic tabs extending slantingly from the board body; each of the plurality of elastic tabs corresponds to each of the plurality of contact switches; each of the plurality of elastic tabs is configured to be pressed to move to contact the corresponding contact switch to input information; the display is configured to rotate towards the base to press the plurality of elastic tabs to move towards the plurality of contact switches to enable the display to contact the board body.

2. The electronic device of claim 1, wherein the board body defines a plurality of openings corresponding to the plurality of elastic tabs; each of the plurality of elastic tabs extends from an edge of each of the plurality of openings; and the plurality of elastic tabs are configured to be pressed to pass through the plurality of openings to enable the display to contact the board body when the display rotates to move towards the board body.

3. The electronic device of claim 1, wherein the plurality of elastic tabs is substantially arc-shaped.

4. The electronic device of claim 1, wherein the board body and the plurality of elastic tabs are made of metal.

5. The electronic device of claim 1, wherein the board body and the plurality of elastic tabs are integrated.

6. The electronic device of claim 1, wherein the plurality of elastic tabs are formed by punching.

7. An electronic device, comprising:
a base comprising a layer of conductive rubber, the layer of conductive rubber comprising a plurality of contact switches;
a display pivotally mounted to one end of the base; and
a keyboard mounted on the base, wherein the keyboard comprises a board body and a plurality of elastic tabs extending slantingly from the board body; the board body defines a plurality of openings corresponding to the plurality of elastic tabs; each of the plurality of elastic tabs corresponds to each of plurality of contact switches; each of the plurality of elastic tabs is configured to be pressed to move into the corresponding opening to contact the corresponding contact switch to input information; the board body is located between the display and the base; the display contacts the board body and the plurality of elastic tabs are pressed by the display to move into the plurality of openings.

8. The electronic device of claim 7, wherein each of the plurality of elastic tabs extends from an edge of each of the plurality of openings.

9. The electronic device of claim 7, wherein the plurality of elastic tabs are substantially arc-shaped.

10. The electronic device of claim 7, wherein the board body and the plurality of elastic tabs are made of metal.

11. The electronic device of claim 7, wherein the board body and the plurality of elastic tabs are integrated.

12. The electronic device of claim 7, wherein the plurality of elastic tabs are formed by punching.
